(19) United States
(12) Patent Application Publication
(10) Pub. No.: US 2021/0366070 A1
(43) Pub. Date: Nov. 25, 2021

(54) SYSTEM AND METHOD OF PROVIDING A NATIONWIDE CHILD PROTECTION DATABASE

(71) Applicant: Nicole D. Reyes-Sime, Lehigh Acres, FL (US)

(72) Inventor: Nicole D. Reyes-Sime, Lehigh Acres, FL (US)

(21) Appl. No.: 16/881,323

(22) Filed: May 22, 2020

(51) Int. Cl. G06Q 50/26; G06Q 50/22; G06Q 10/10; G06Q 30/00; G06Q 50/18; G06Q 50/20; G06F 16/9535; G06F 16/23

(52) U.S. Cl. CPC G06Q 50/265; G06Q 50/22; G06Q 10/105; G06F 16/2379; G06Q 50/18; G06Q 50/20; G06F 16/9535; G06Q 30/0185

(57) ABSTRACT

A system and method for providing a social services database, and more specifically, a system and method for providing a nationwide child protection reporting database is disclosed. The system includes a report uploader receiving and processing an incoming child protection report received from remote state data sources, a report correlator for searching the nationwide child protection reporting database for matching records based upon listed individuals in the incoming child protection report, a database search engine, a database inserter/updater for inserting child protection reports received from the report updater and for updating existing data records identified by the report correlator, and an agent query processor for searching the nationwide child protection reporting database for matching records based upon a search query received from a user. A pair of records are considered to be a match when a listed individual in each record references the same party.

### TECHNICAL FIELD

This application relates in general to a system and method for providing a social services database, and more specifically, to a system and method for providing a nationwide child protection reporting database.

### BACKGROUND

Various agencies and supporting service providers benefit from obtaining all relevant information regarding a child and the related family situation when children are being protected by governmental entities. Currently, most agencies and states maintain individual records on investigations, placements, family arrangements, and all relevant circumstances involving a child and family. These records are typically different from each other and are generally not accessible to authorized entities and individuals when they are attempting to assist a child in a difficult situation. This problem gets worse when families move between jurisdictions and related family members are residents of different states. A case worker trying to assist a child may not easily be able to learn all relevant information as arrangements are being made for the child. Additionally, parents and other caregivers may easily avoid government efforts to assist the child simply by moving to a different state and rely on the fact that the relevant information is not likely to follow them. All of these issues result in responsible parties not being able to provide the best available service and protection for children in difficult circumstances.

Therefore, a need exists for a providing all authorized entities and individuals access to complete information regarding a child that comes under their jurisdiction for protection. Recognition of a child's birth and the identity of the parents, all contacts the child has with any child protection entity, and cross-checking these records against available death certificates for underaged parties are all needed to be available to a case worker when a child is to be protected. The information must be easily accessible, must be up-to-date with all records, and must contain records from all available jurisdictions. None of these conditions exist in available on-line and searchable data sources. The present invention addresses these inadequacies of the current system according to the system and method disclosed herein.

### SUMMARY

In accordance with the present invention, the above and other problems are solved by providing a system and method for a nationwide child protection reporting database according to the principles and example embodiments disclosed herein.

In one embodiment, the present invention is a system for providing a nationwide child protection reporting database. The system includes a report uploader receiving and processing an incoming child protection report received from remote state data sources, a report correlator for searching the nationwide child protection reporting database for matching records based upon listed individuals in the incoming child protection report, a database search engine, a database inserter/updater for inserting child protection reports received from the report updater and for updating existing data records identified by the report correlator, and an agent query processor for searching the nationwide child protection reporting database for matching records based upon a search query received from a user. A pair of records are considered to be a match when a listed individual in each record references the same party.

In another embodiment, the present invention is a method for providing a nationwide child protection reporting database. The method receives a child protection report from a state run data server, adds the child protection report to the nationwide child protection reporting database, searches the nationwide child protection reporting database for data records matching individuals listed on the child protection report, when a matching record is found in the nationwide child protection reporting database, updates and cross references the child protection report to all matching records, searches the nationwide child protection reporting database for data records having potential reference to matching individuals listed on the child protection report, and when a record containing a child now considered an adult is found in the nationwide child protection reporting database, submits the database records found to contain a potential matching record to individuals listed on the child protection report to a human operator for validation.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system that provides a nationwide child protection reporting database according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIGS. 3a-b illustrate example child services data records imported by a system for providing a nationwide child protection reporting database according to the present invention.

FIG. 4 illustrates a computing system of software components providing a nationwide child protection reporting database according to the present invention.

FIG. 5a-c illustrates a flowchart corresponding to a method performed by software components providing a nationwide child protection reporting database according to the present invention.

### DETAILED DESCRIPTION

This application relates in general to a system and method for providing a social services database, and more specifically, to a system and method for providing a nationwide child protection reporting database. Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The terms “client,” and “user” refer to an entity, e.g. a human, using the nationwide child protection reporting database including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or to a wireless connection(s) using any type of frequency/frequencies or radio wave(s). Some examples are included below in this application.

The term “invention” or “present invention” refers to the invention being applied for via the patent application with the title “System and Method for Providing a Nationwide Child Protection Database.” Invention may be used interchangeably with database and system.

The terms “communicate”, or “communication” refer to any component(s) connecting with any other component(s) in any combination for the purpose of the connected components to communicate and/or transfer data to and from any components and/or control any settings.

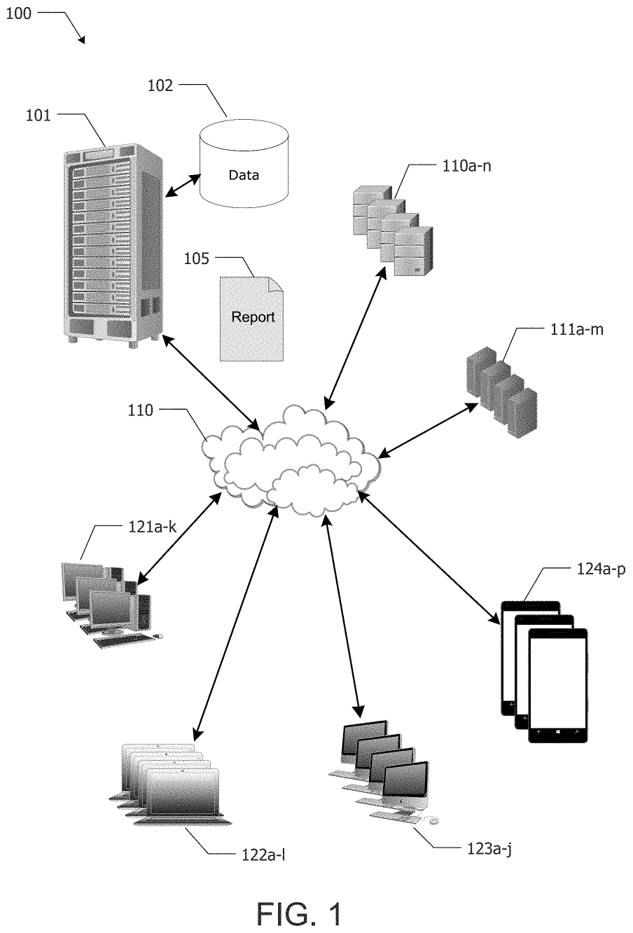

In general, the present disclosure relates to a system and method for providing a nationwide child protection reporting database. To better understand the present invention, FIG. 1 illustrates an example embodiment for a system 100 providing a nationwide child protection reporting database according to the present invention. A central server 101 coupled to a permanent data store 102 is accessible over the Internet 110 by authorized entities all over the United States. State child protective services agencies' records and related juvenile court records from all of the state run data servers l 12a-n are connected to the central server 101. Newly created case records from these state run data servers l 12a-n are periodically uploaded to the central server 101 for inclusion into a nationwide child protection database 102a. Newly created records from other data sources 11la-m, such as police reports, school criminal referrals, and court records also may be periodically uploaded to the central server for inclusion in the nationwide child protection reporting database 102a.

Authorized users from courts and related attorneys 12la-k, child protection agents 122a-l, and authorized police officers and school officials 123a-j may search the nationwide child protection database 102a with a user account at the central server 101 and the submission of a search query. All of the above parties may also access the nationwide child protection database 102a using a smartphone 124a-p or other portable computing device while these individuals are away from the office to provide important and relevant information quickly while these agents are actively engaged in a case.

All data may be protected from inadvertent access by encrypting all data communications between the central server 101 and remote servers and computing devices. Use of secure Virtual Private Networks (VPNs) between the central server 101 and remote devices also may be used. User account access to submit a query and receive results may require a multi-factor user authentication and authorization process before any additional communication is permitted. Logging all search and data access activity to provide easy accountability to supervisors and other individuals with oversight authority may assist in quickly identifying and stopping unauthorized data access for the protection of a child's privacy interests. Finally, automatic removal of non-children from the database once the individual has reached the age of majority or is otherwise declared an adult should minimize inappropriate access to these confidential records once the child protection system in no longer responsible for or has jurisdiction over the individual. The removed records may be retained within a backup data source for retrieval using a warrant or subpoena approved by a court.

Regular upload of data may occur as the central server 101 and supporting data sources routinely communicate on a daily or weekly basis to maintain new data records. Processing new data within the central server 101 may include obtaining data in a variety of different data formats, translating the data into a common data structure, identifying related data for the child and family may be automatically performed as the translated and reformatted data records are stored in the nationwide child protection database 102a. The database may also automatically index all incoming data to assist in rapid searching by authorized parties. All of these processes will provide case workers and other parties the data they need to provide the best and most informed protection of children in difficult situations while protecting these children and their families from harm via improper disclosure of the information.

The present invention may use any type of network such as a single network, multiple networks of a same type, or multiple networks of different types which may include one or more of a direct connection between devices, including but not limited to, a local area network (LAN), a wide area network (WAN) (for example, the Internet), a metropolitan area network (MAN), a wireless network (for example, a general packet radio service (GPRS) network), a long term evolution (LTE) network, a telephone network (for example, a public switched telephone network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals like Bluetooth™, wireless fidelity, infrared, Wi-Fi or LTE. Any smart device mentioned in this application may be connected to any other component or smart device via wired communications (e.g., conductive wire, coaxial cable, fiber optic cable, ethernet cable, twisted pair cable, transmission line, and waveguide), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods are described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general purpose computing devices may be used as well. In at least one embodiment, all of the services described herein are provided using web pages being accessed from a web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 105. These computing devices may include smartphones 101a, laptop computers 101b, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

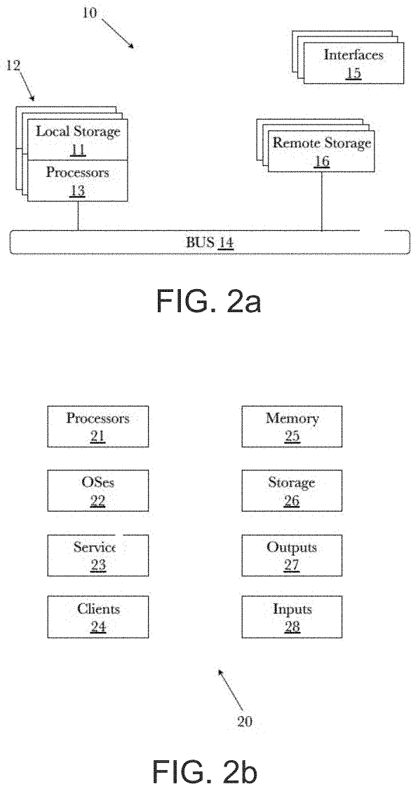

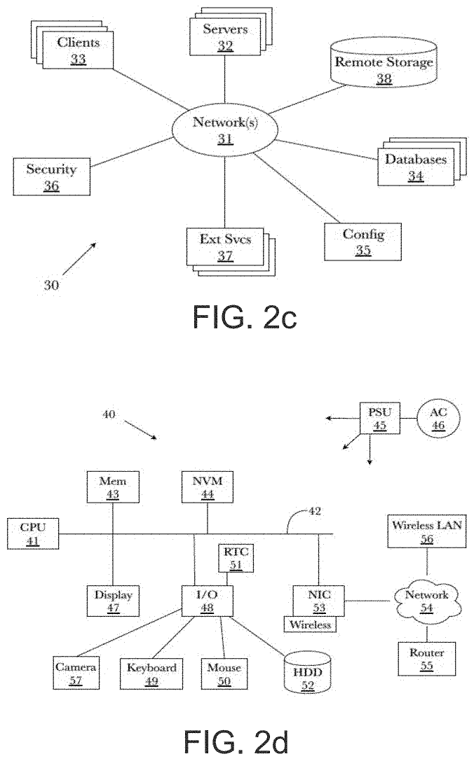

Referring now to FIG. 2a, there is a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, computing device 10 includes one or more central processing units (CPU) 12, one or more interfaces 15, and one or more buses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip- (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale interfaces (POS), fiber data distributed interfaces (FDDis), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks; and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks or other such removable media, and that such integral and removable storage media may be utilized interchangeably. Examples of program instructions include both object code, such as may be produced by a compiler, machine code, such as may be produced by an assembler or a linker, byte code, such as may be generated for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system or the like. In many cases, one or more shared services 23 may be operable in a system 20, and may be useful for providing common services to client applications 24. Services 23 may, for example, be WINDOWS™ services, user-space common services in a LINUX™ environment or any other type of common service architecture used with an operating system 21. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to a system 20, and may include, for example, one or more screens for visual output, speakers, printers or any combination thereof. Memory 25 may be RAMhaving any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in Fig. B. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information or to refer to additional data concerning a particular call. Communications with external services 37 may take place, for example, via one or more networks 31. In various aspects, external services 37 may comprise web-enabled services or functionality related to or installed on the hardware device itself For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to a bus 42, to which bus is also connected to memory 43, nonvolatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

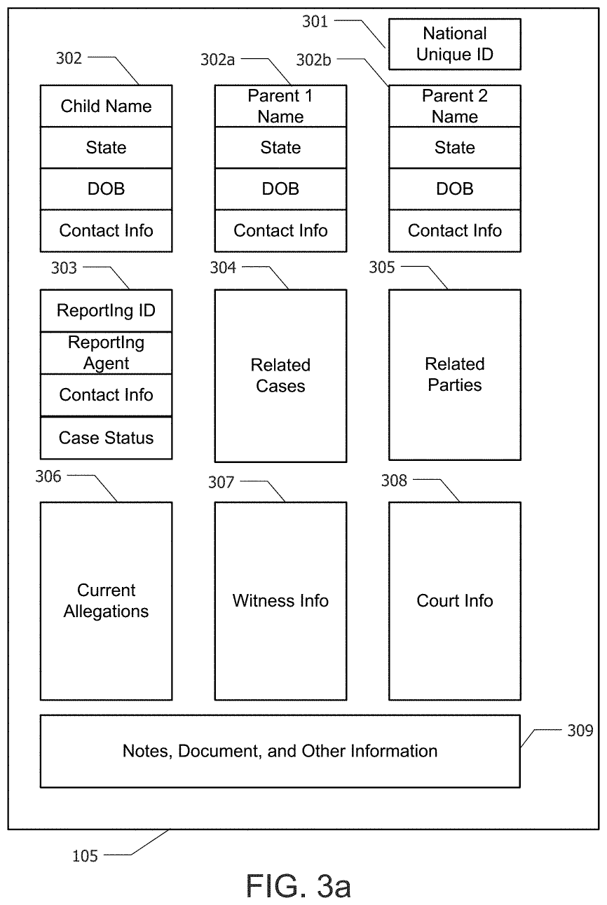

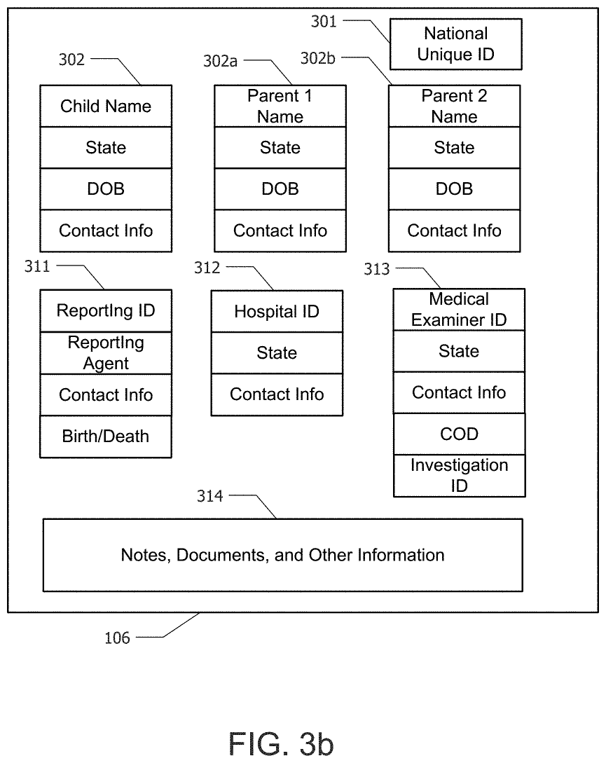

FIGS. 3a-b illustrate example child services data records imported by a system for providing a nationwide child protection reporting database according to the present invention. FIG. 3a shows an example child contact data report 105 provided from a state run data server l 12a-n to a central server 101. The child contact data report 105 is periodically uploaded from the state run data servers l 12a-n and processed by the nationwide child protection database 102a.

The child contact data report 105 includes a national unique ID 301, child identity information 302, parent 1 identity information 302a, parent 2 identity information 302b, reporting entity information 303, related cases information 304, related parties information 305, current allegations or issues data 306, witness identification information 307, relevant court proceedings 308, and notes, documents, and other information 309.

The national unique ID 301 is used by the nationwide child protection database 102a to identify each child data report. This unique ID is necessary for keeping all of the children and their related incidents and actions separate from each other. This set of data may also include references to other identifying report numbers assigned by the state run data server l 12a-n and/or their relevant agencies or entities.

The child identity information 302, parent 1 identity information 302a, and parent 2 identity information 302b all contain identifying information regarding the child in question and the two parents of record. This information may include name, aliases, state of residence, date of birth, contact information such as address, email, phone number, and social security number, and other useful information that may be relevant to the identity and current location of the individual. If individual data sources provide additional information, that may be entered into data set as well. If some of these data values are not present or not provided in the record received from the state run data server l 12a-n, the nationwide child protection database 102a may record the data field as being empty or not provided.

The reporting entity information 303 provides a reference to searchers of the nationwide child protection database 102a identifying the source of the data record and its contents. The reporting entity information 303 may include the name or ID of the reporting entity such as the name of the state or county agency generating the data, identity and contact information fora responsible agent or employee of the reporting entity, case ID and status, and all related information regarding the legal process that gave rise to the information in the child data report 105.

The related cases information 304 provides references to all related child data reports 105 entered into the nationwide child protection database 102a for this child and the identified parents. This field may simply include the national unique ID 301 for these related reports that would permit the searcher to access all of the data that may involve these individuals and that may provide relevant information regarding the current incident that caused the child data report 105 to be generated.

The related parties information 305 provides identifying information and contact information for all other related parties not otherwise identified in the child data report 105. For example, other family members, grandparents, guardians, social workers, therapists and the like could be identified in this relevant parties information 305. Such information being readily accessible in one place may provide a current case worker with contacts to others who may help the current case worker understand any circumstances present in the child's life or family. The information may also include dates and other child data reports 105 in which the relevant party may have knowledge and insight.

The current allegations or issues field 306 provides a statement for the reason the child has been brought into contact with the child protection system. This information may reference specific charges or violations, contents of required reporting data from professionals with an obligation to report abuse, and similar descriptive information to explain the existence and relevance of the child data report 105 to the child. The content and scope of this data may be determined by the specific state run entity generating the report. The nationwide child protection database 102a may translate state- or locality-specific charges into a common statement of reason for the record and may add a reference to a definition of the relevant charges or violations in the particular jurisdiction to aid searchers in understanding records and allegations from distant localities.

The witness identification information 307 provides identifying information and contact information for all witnesses and similar related parties not otherwise identified in the child data report 105. Such information may be useful in a current case to understand and document recurring patterns of behavior related to the child and family. As noted above, not all jurisdictions and child data reports 105 may include this type of data; however, when present, the information may be useful to searchers and current case workers.

The relevant court proceedings 308 identifies all relevant court proceedings involving the child and/or parents associated with the current child data report 105. The court proceedings information may include the identity of the court, the assigned or deciding judge, attorneys for the state, child, and other parties, case status, and contact information for all named individuals. This data is distinguishable from the related cases information 304 in that the relevant court proceedings 308 refers to actual judicial cases before a court, where the related cases information 304 may include other child data report 105 data.

The notes, documents and other information field 309 provides a storage location in the nationwide child protection database 102a to capture any other notes or other information that is present in a case associated with the child data report 105. The related documents may include supporting documents such as police or school incident reports, medical exam records, charging documents, and the like which may provide supporting evidence regarding the events generating the child data report 105.

The child data report 105 may also include any other jurisdiction-specific data that may be provided by agencies and case workers for the state-run data sources to the nationwide child protection database l 12a-n. The intent of the nationwide child protection database 102a is to provide a centralized location for all relevant data associated with a child so that parties handling a case involving the child may easily obtain relevant data permitted to be shared without the need to search in a large number of places and different computer systems to find useful information.

FIG. 3b shows a child life event report 106 that may be received from data sources and included within nationwide child protection database 102a. The nationwide child protection database 102a also records the birth and death of all children such that a child data report 105 may be correlated with identifying information regarding the child, parents, and family. A child life event report 106 may include a national unique ID 301, the child identity information 302, the parent 1 identity information 302a, the parent 2 identity information 302b, and the reporting entity information 311 that are similar to function and content of the corresponding data within the child data report 105 described above in reference to FIG. 3a. The reporting entity information 311 may include state birth reports and state medical examiner reports that involve children. As such the reporting entity information 311 includes a data field indicating whether the child life event report 106 refers to a birth or a death.

The child life event report 106 may also include hospital information 312, medical examiner data 313, and notes, documents and other information 314. The hospital information 312 may include identifying date for a hospital or other facility that was involved in a birth or death of a child. The hospital information 312 may include an identity, location, contact information, relevant dates of treatment, and treating physicians or health care providers involved in the event.

The medical examiner data 313 may include a death certificate, post-mortem exam report, responsible medical examiner identity, location, contact information, and dates of examinations. In many cases, this data may simply include the date of death, cause of death, and relevant names, locations, and dates. In other cases, this data may also refer to investigation data that is associated with the death and medical examiner conclusions as appropriate.

The notes, documents, and other information 314 provides a storage location in the nationwide child protection database 102a to capture any other notes or other information that are present in a case associated with the child life event report 106. The related documents may include supporting documents such as police or school incident reports, medical exam records, charging documents, and the like which may provide supporting evidence regarding the event(s) that generated the child life event report 106.

The child life event report 106 may be correlated with any child data report 105 involving the child by the nationwide child protection database 102a and by the state-run data sources l 12a-n. The nationwide child protection database 102a may automatically process incoming and updated child data reports 105 to match these reports with other data in the nationwide child protection database 102a. Any matches found in this processing may be screened by personnel of the nationwide child protection database 102a to validate the matches as being accurate before the matched records are updated to reference each other as appropriate. The automated matching and validating of records adds significant value to the data when searched by authorized parties as the data may be trusted and not inappropriately disclosed without due cause.

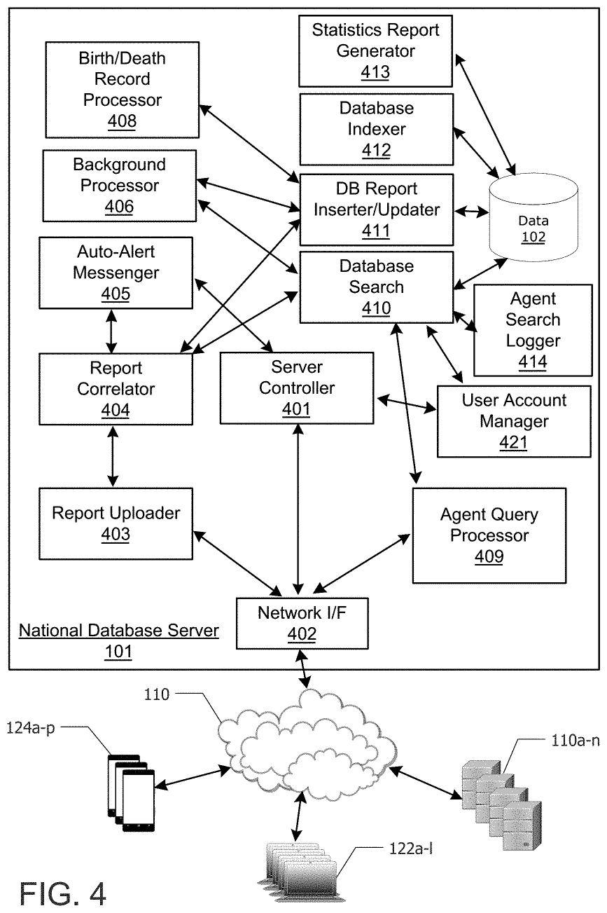

FIG. 4 illustrates a computing system of software components providing a nationwide child protection reporting database according to the present invention. The central server 101 implements the nationwide child protection database 102a using a set of data processors running on the central server 101. The central server 101 includes a: server controller 401, network interface 402, report uploader 403, report correlator and validator 404, auto-alert messenger 405, background processor 406, life event report processor 407, agent query processor 411, database search engine 410, database report insertion and updater 411, database indexer 412, statistic report generator 413, agent search logger 414, and user account manager 421. All of these processes work together to comprise the nationwide child protection database 102a.

The server controller 401 performs all of the logical operations needed to receive child data reports 105 and the child life event reports 106 from various data sources, updates and maintains a searchable database, receives and responds to authorized individuals' search queries, and performs related search processing. In a typical embodiment, this control processor may be an embedded programmable processing device that executes firmware stored within local memory.

The network interface 402 provides a mechanism for a central server 101 to communicate with remote devices over the Internet 110. This network interface 402 also uses the supported hardware and corresponding software application program interfaces [APis] to provide the network communications needed to interact with remote devices such as state-run data sources l 12a-n.

The report uploader 403 provides a mechanism for periodically receiving child data reports 105 child life event reports 106 from remote data sources for inclusion into the nationwide child protection reporting database 102a. The report uploader 403 parses and reformats incoming data into a standard data format and organization. The report uploader 403 may include a set of data translation rules for each of the different data sources to account for the variation in the incoming report formats.

The report correlator and validator 404 processes incoming child data reports 105 received from the report uploader 403 against existing data within the nationwide child protection reporting database 102a. The report correlator and validator 404 identifies existing child data reports 105 referencing the same child and parents. The report correlator and validator 404 may determine a level of confidence for the match of the data depending upon the nature and amount of matching data, the sources of the various records, and past indications of data validation with other child data reports 105. Matching data with a level of confidence above a predefined matching value may be automatically updated in all of the related child data reports 105 without additional operator intervention. Matching data with a level of confidence below the predetermined matching value are stored within the report correlator and validator 404 for manual review and validation before the new data is added to nationwide child protection reporting database 102a and all of the relevant child data reports 105.

The auto-alert messenger 405 receives an indication of all matches between an incoming child data report 105 and any existing child data reports 105 within the nationwide child protection reporting database 102a. When the data from the incoming child data report 105 is validated and added to the nationwide child protection database 102a by the report correlator and validator 404, the auto-alert messenger 405 searches the existing child data reports 105 within the nationwide child protection database 102a to identify case workers and other interested parties in active matters that may be interested in the new child data report 105, but who are not likely to have received notice of the report. The auto-alert messenger 405 may generate a message such as an email, text message or similar digital communication providing the case workers and other interested parties with notice and reference to the new data in the nationwide child protection database 102a. This function will automatically inform these interested individuals so that they may obtain the data and respond accordingly.

The background processor 406 is a processing task which may run when the processing activity on the central server 101 is low to search the database for additional matches between various child data reports 105 that do not have an immediate indication of a match. For example, in a child data report 105 containing a child name, DOB, SSN, address, and identified parents that is identical to an existing child data report 105, the match may be easily correlated and validated. The incoming child data reports 105 and existing child data reports 105 may, however, contain similar but not identical data caused by A comparison of additional data fields including dates, locations, witnesses, and the like may suggest additional possible matches between an incoming child data report 105 and existing child data reports 105. The processing required to perform an exhaustive search during the initial correlation and validation process may be such that looking for these less likely matches would be too time intensive for normal processing of an incoming child data report 105. However, making such matches and permitting an operator of the central server 101 to validate the possible match may lead to additional correlation of reports without providing the less likely matches each time a search query is processed by an authorized party. Because the searching and data matching is performed as a background task, the effort to identify these less likely record matches may occur without impacting the primary processing of the nationwide child protection database 102a.

The life event report processor 407 performs the data translation functionality of the report uploader 403 and the data report matching of the report correlator and validator 404 for life event reports 106 received by the nationwide child protection reporting database 102a. The life event report processor 407 understands the details of birth and death reports and how the data from these reports relate to the child data report 105 in the nationwide child protection database 102a. The life event report processor 407 will generate data for the nationwide child protection database 102a and cause it to be inserted into the database appropriately.

The agent query processor 411 receives a search query from courts and related attorneys 121a-k, child Protection agents 122a-1, and authorized police officers and school officials 123a-j to search the nationwide child protection reporting database 102a for information. The search query will typically provide identifying information such as a child or parents name, a case reference ID or other data known to be in the nationwide child protection database 102a. The agent query processor 411 parses the query and submits the search request to the database search engine 410 that generates search results which are turned to the agent query processor 411 for formatting and return to the requesting entity. The agent query processor 411 may utilize a Boolean search string, data matching within specified database record fields, and other query specification commands. The agent query processor 411 also utilizes the user account manager 421 to authenticate the identity of the requesting party and determine whether that party is authorized to receive the data returned from the search. Non-authorized data records may be deleted from the search results and the requesting party may only receive data in which he/she is entitled.

The database report insertion and updater 411 is responsible for adding the child data reports 105 processed by the report correlator and validator 404 and the child life event reports 106 processed by the life event report processor 407 into the nationwide child protection reporting database 102a. The database report insertion and updater 411 ensures that the update does not occur while a pending search involving the data records is occurring. Only the database report insertion and updater 411 may update searchable database data to ensure that only validated and trusted data be used when search queries are being processed.

The database indexer 412 will process all incoming data added to the nationwide child protection database 102a by the database report insertion and updater 411 to maintain all database search indexes used to speed searching of the nationwide child protection database 102a. The database indexer 412 may maintain a set of indexes that are tailored to efficiently perform various types of common searches such that the majority of search queries may be quickly processed. These indexes may be updated, periodically recreated, and maintained doing off-peak times to keep the database running as efficiently as possible.

The statistic report generator 413 provides a mechanism for searchers to perform various statistical analyses and report generation regarding various types of child protection cases by date, locality, court, type of violation, and the like for social scientist researchers. The statistic report generator 413 will generate the analysis and corresponding results without referencing identifying information of individual children, parents, and related parties. Such a search function may provide a useful source of data for research while maintaining the anonymity of the individuals in the nationwide child protection reporting database 102a.

The agent search logger 414 receives a record of every search query processed by the agent query processor 411 and the database search engine 410 that includes the data and time of the query submission, the identity, authentication, and authorization determination for the search generated by the user account manager 421, and useful network data such as IP address, device MAC address, cell phone IMEi number, and all similar identification information to allow verification of the recipient of the search results. The agent search logger 414 creates a searchable log file for each day that may be checked by responsible supervisors and investigators when misuse or abuse of the nationwide child protection reporting database 102a data is suspected.

The user account manager 421 maintains the user ID, password, user identity and contact information, multi-factor authentication data, access rights, and periodic credential expiration information that is used to ensure only authorized parties may access and obtain data from the nationwide child protection database 102a. The user account manager 421 processes a user's login attempts to create a search session using the user ID, password, and multi-factor authentication data as needed. Once a user logs into the central server 101, the user account manager 421 determines on an individual search query basis whether particular search results are to be returned to the requestor by the agent query processor 411.

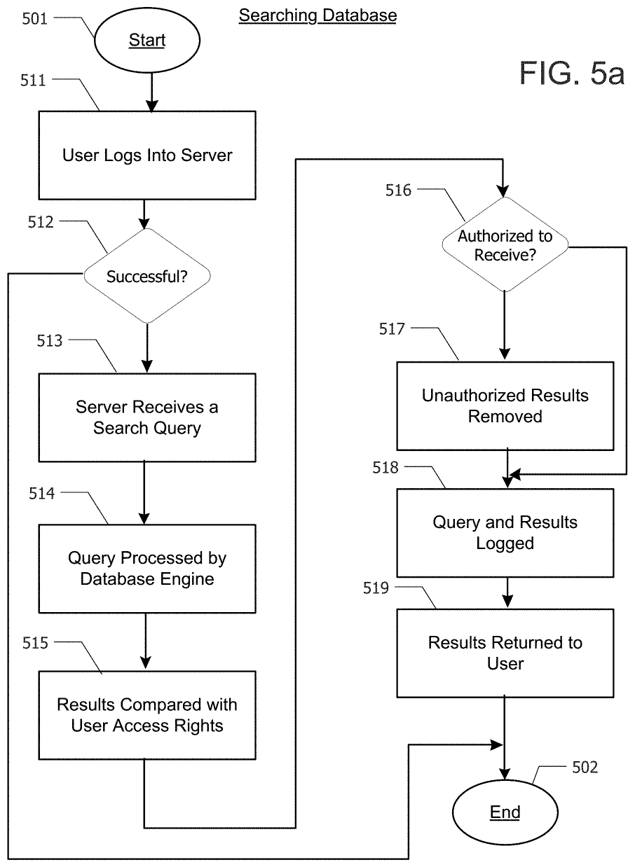

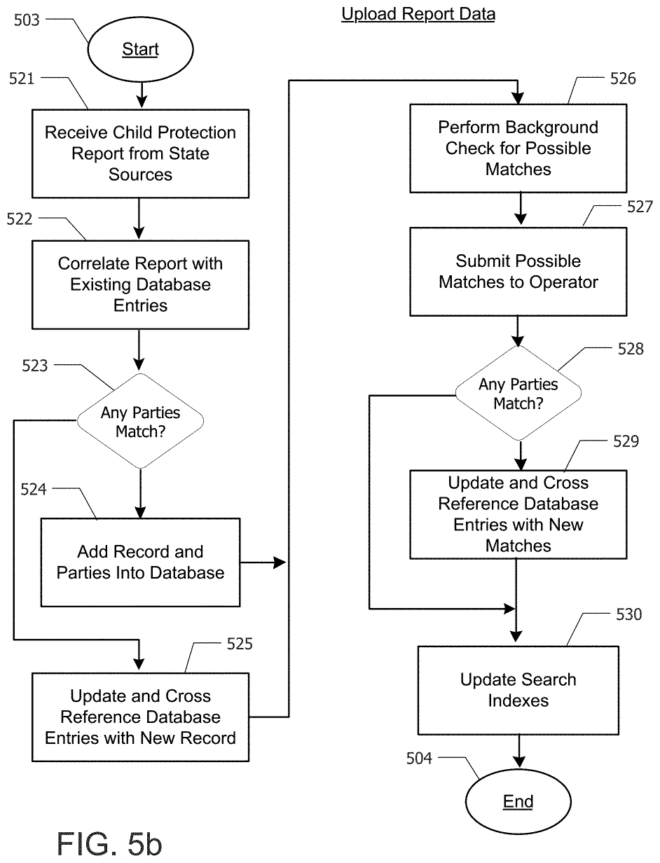

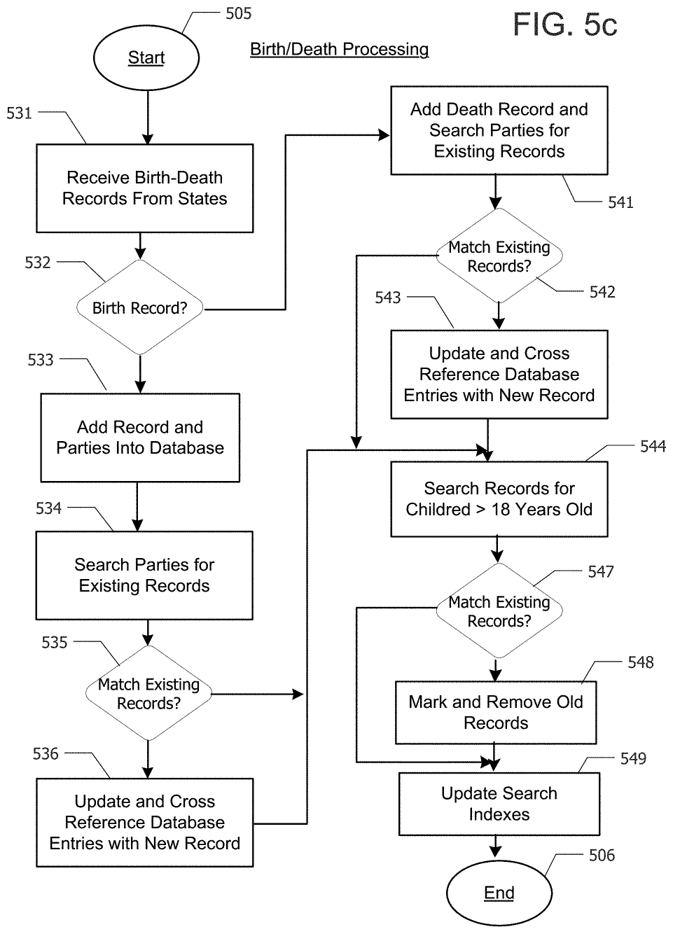

FIGS. 5a-c illustrate flowcharts corresponding to a method performed by software components providing a nationwide child protection reporting database according to the present invention. Fig. Sa illustrates a flowchart for searching the nationwide child protection reporting database according to the present invention. Fig. Sb illustrates adding child protection records to the nationwide child protection reporting database according to the present invention. Fig. Sc illustrates adding state Birth and Death Records to the nationwide child protection reporting database according to the present invention.

In Fig. Sa, the method for searching the database starts 501 with step 511 having a user log into the remote server using a user ID and password. Multi-factor authentication may also be used in this step. Test step 512 determines whether the user is authorized to access the database, and if not, the process ends 502. If test step 512 determines that the user is authorized to access the database, the server receives a search query from the user in step 513.

Upon receipt, the agent query processor 411 parses the query and submits the search request to the database search engine 410 in step 513. The database engine 410 processes the query in step 514 and compares ant search results with the user's access rights in step 515. Test step 516 determines whether the user is authorized to receive the particular results found by the database engine 410, and when some of the records are not authorized, these particular search results are removed from the search result returned by the database engine 410 in step 517.

With the search results now complete, step 518 logs the query and generated results into a permanent log file and the completed search results are returned to the user in step 519 before the process ends 502.

Fig. Sb shows the uploading of child protection reports and their insertion into the database. The process begins 503 with step 521 receiving a set of reports from a state data source. Step 522 correlates each report within the set of reports with existing records within the database. This correlation step identifies all existing records in the database that reference the same parties as the incoming record. Test step 523 determines if any matching records were identified, and if not, the incoming record is simply added to the database in step 524. When test step 523 finds matching records, step 525 updates and cross references the existing database records with the new incoming record that include adding the new record into the database.

Once all of the new report records have been processed, step 526 performs background checks with the newly added records with all of the other database records identifying possible matching parties. This processing step takes into account abbreviations and misspelling of names, transposing and miss entering date numerals, and similar data errors that prevent a record to be identified as a match. These possible matching records are submitted to a human operator in step 527 for review and validation. The operator may perform any necessary investigation to ensure that potentially matching parties in the records do in fact reference the same individual.

Test step 528 determines whether the operator has validated a potential matching record, and if not, the process continues to step 530 where the search indexes to the database are updated before the process ends 504. When test step 528 determines that a validated match has been generated by the human operator, step 529 updates and cross references the validated matching records with all other known matching records to maintain an accurate and complete database as possible. Once the updates are performed, the search indexes are updated in step 530 and the process ends 504.

Fig. Sc shows the processing of childbirth and death records received from various state sources. The process begins 505 with step 531 receiving an incoming child record. Test step 532 determines whether the incoming child record corresponds to a birth record or a death record, and when a birth record is identified, step 533 adds the birth record to the database. Next step 534 searches the database for any matching parents from the incoming birth record with existing records in the database. This search typically identifies information regarding siblings of the child identified in the incoming birth record or other references to the parents in ay database records. Test step 535 determines whether matching references to the parents are found in existing database records. When a matching record is found, the incoming birth record is added and cross references to all relevant records in the database in step 536, otherwise the process skips step 536.

The process continues at step 544 in which the database is searched for child records identifying any children who are now considered an adult. This change in status for a child typically occurs at his or her 18th birthday. Test step 547 determines whether any matching records containing an individual no longer considered a child is found. When such a matching record is found, step 548 marks and removes all records from the database. In this step, the process marks records as now containing an adult when this record or related records still reference individuals considered a child. As such, the database engine does not return the records in search results that match a marked name while retaining the record for access by searches for any of the other referenced individuals are a child. The record may be removed from the database when all of the referenced individuals in all related records are now considered an adult. As such, the database will maintain only records and provide search results for only children. The removed records may be maintained in a separate database if desired for other purposes beyond the child protection served by the present invention. Once all of the database records have been marked or removed, the search indexes are updated in step 549 before the process ends 506.

Returning to test step 532, when this test determines the incoming child record is a death record, step 541 adds the incoming child record to the database and searches the database for references to the deceased child or the parents. Test step 542 determines whether a matching record is found. When a matching record has been found, the incoming death record cross references to all relevant records in the database in step 536 in which all of these records are updated; other the process continues directly to step 544 to search for individuals now considered an adult as describe above and the processing follows the same path to the process conclusion 506.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps or modules.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

What is claimed:

1. A system for providing a social services database, and more specifically, a system for providing a nationwide child protection reporting database, the system comprising:
a report uploader receiving and processing an incoming child protection report received from remote state data sources;
a report correlator for searching the nationwide child protection reporting database for matching records based upon listed individuals in the incoming child protection report;
a database search engine;
a database inserter/updater for inserting child protection reports received from the report updater and for updating existing data records identified by the report correlator; and
an agent query processor for searching the nationwide child protection reporting database for matching records based upon a search query received from a user;
wherein a pair of records are considered to be a match when a listed individual in each record references the same party.

2. The system according to claim 1, wherein the system further comprises:
a user account manager for authenticating users search the nationwide child protection reporting database and managing record access rights for the user; and
an agent search logger for maintaining a record of all search queries performed with the search records returned to the user.

3. The system according to claim 2, wherein the system further comprises:
a background processor for searching the nationwide child protection reporting database for potential matching records to be manually validated by a human operator; and
a birth-death child record processor for inserting birth-death child record into the nationwide child protection reporting database.

4. The system according to claim 1, wherein the remote state data source that generates the incoming child protection report are a state run data server.

5. The system according to claim 3, wherein the birth-death child record are uploaded from a state run data server.

6. A method for providing a social services database, and more specifically, a method for providing a nationwide child protection reporting database, the method comprising:
logging a user into the nationwide child protection reporting database;
submitting a search query to the nationwide child protection reporting database from the user;
generating search results from the search query;
eliminating any data from the search results that the user not authorized to receive;
logging the search query and search results into a permanent data log. and
returning the search results to the user;
wherein a pair of records are considered to be a match when a listed individual in each record references the same party.

7. The method according to claim 6, wherein the method further comprising:
receiving a child protection report from a state run data server;
adding the child protection report to the nationwide child protection reporting database;
searching the nationwide child protection reporting database for data records matching individuals listed on the child protection report;
when a matching record is found in the nationwide child protection reporting database, updating and cross referencing the child protection report to all matching records;
searching the nationwide child protection reporting database for data records having potential reference to matching individuals listed on the child protection report; and
when a record containing a child now considered an adult is found in the nationwide child protection reporting database, submitting the database records found to contain a potential matching record to individuals listed on the child protection report to a human operator for validation.

8. The method according to claim 7, wherein the method further comprising:
receiving a birth-death child record from the state run data server;
adding the birth-death child record to the nationwide child protection reporting database;
searching the nationwide child protection reporting database for data records matching individuals listed on the birth-death child record;
when a matching record is found in the nationwide child protection reporting database, updating and cross referencing the birth-death child record to all matching records;
searching the nationwide child protection reporting database for data records having reference to a child now considered an adult; and
when a record containing a child now considered an adult is found in the nationwide child protection reporting database, marking and removing the database records found to contain a child now considered an adult.

9. The method according to claim 7, wherein the method further comprising generating an auto alert message to interested parties based upon insertion of the child protection report and the birth-death child record into the nationwide child protection reporting database.

10. The method according to claim 9, wherein the user comprises courts and related attorneys, child protection agents, authorized police officers, and school officials.
